(19) United States
(12) Patent Application Publication
(10) Pub. No.: US 2006/0068792 A1
(43) Pub. Date: Mar. 30, 2006

(54) System and method for using determination of the operating parameters of a mobile device

(75) Inventors: Damodaran Vasudevan, Palatine, IL (US); Tushar Raval, Vernon Hills, IL (US); Gary E. Western, Johnsburg, IL (US)

Correspondence Address: MOTOROLA, INC., 1303 EAST ALGONQUIN ROAD, IL01/3RD, SCHAUMBURG, IL, 60196, US

(73) Assignee: Motorola, Inc.

(21) Appl. No.: 10/955,475

(22) Filed: Sep. 30, 2004

(51) Int. Cl. H04Q 7/20

(52) U.S. Cl. 455/444; 455/443

(57) ABSTRACT

A system and method of determined selected operating parameters for a mobile unit (102). Mobile device performance information is monitored in at least one neighboring cell (108, 110, or 112) and mobile device performance information is monitored in a serving cell (106). Selected operating parameters of a mobile device (102) are determined based upon the mobile device performance information in the at least one neighboring cell (108, 110, or 112) and the mobile device performance information in the serving cell (106).

### FIELD OF THE INVENTION

The field of the invention relates to wireless communication systems and more specifically to mobile devices within these systems.

### BACKGROUND OF THE INVENTION

Wireless communication devices such as cellular telephones and pagers are well known. These mobile devices typically operate within communication cells using a particular coding scheme to communicate with each other and with other users. Examples of coding schemes include the General Packet Radio Service (GPRS) coding scheme and the Enhanced General Packet Radio Service (EGPRS) coding scheme. The mobile devices can also move between cells and a handoff occurs when the mobile communication device passes from a first cell to a second cell.

One important consideration concerning the operation of a wireless system or network is the perceived quality of service provided to the user at a mobile device. The perceived quality of service can be determined in different ways. For example, one can measure the strength of a received signal at a mobile device within a cell in the network.

In some previous systems, a mobile device may search for a new cell in order that the perceived quality of service for the mobile is improved. The determination of the identity of the new cell is typically made according to static and unchanging cell reselection criteria. For example, if it is determined that a new cell is required, the new cell selected may always be the strongest cell the mobile sees.

These previous systems suffer from certain problems and shortcomings. As indicated above, in previous systems, the selection of a new cell and the resultant starting coding scheme used in the new cell is not dynamic, but based instead upon static and unchanging criteria or relationships. In other words, the actual radio frequency (RF) operating conditions of a mobile unit within a particular cell are not considered in making cell or coding scheme selection determinations. As one example of the limitations of previous systems, during cell reselection, the network is unable to select the optimum coding scheme or new cell due to variations in cell topology, terrain, environmental conditions, or other variable conditions.

Furthermore, in previous systems, the initial coding scheme used by a mobile is specified by the operator and applies to all mobile devices within a cell regardless of the RF conditions. Variations based upon individual requirements are not typically allowed. Another problem associated with previous systems is that end user throughput is sometimes reduced when the system control unit determines the optimal channel coding scheme to service a mobile device.

### BRIEF DESCRIPTION OF THE DRAWINGS

The above needs are at least partially met through provision of the system and method for determination of the operating parameters of a mobile device described in the following detailed description, partially when studied in conjunction with the drawings, wherein:

FIG. 1 is a block diagram of a system for determination of cell boundary information according to various embodiments of the present invention;

FIG. 2 is a flow chart of a method for the determination of cell boundaries according to various embodiments of the present invention; and

FIG. 3 is a diagram of a look-up table according to various embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE PREFERRED EMBODIMENT

A system and method for determining cell boundaries and coding scheme information uses the measured operating conditions of a mobile unit in making determinations of operating parameters of a mobile device. More specifically, the system and method determines optimum cell boundaries and other operating parameters for a mobile unit based upon received performance information. The determination is made quickly and efficiently resulting in an enhanced user experience with the system.

In many of these embodiments, the system monitors mobile device performance information in at least one neighboring cell and mobile device performance information in a serving cell. The system then determines selected operating parameters of a mobile device based upon the mobile device performance information in the at least one neighboring cell and the mobile device performance information in the serving cell. With this approach, variations in cell topology, terrain, environmental conditions, or other variable conditions are taken into account when determining the operating parameters of the mobile.

The selected operating parameters may be applied to the mobile device and the system may determine whether at least one performance characteristic of the mobile device is improved using the selected operating parameters. The system may also initialize the selected operating parameters of the mobile device based upon at least one stored historical measurement.

A computer memory may store a table, for example, a multidimensional array, that includes the parameters. The table provides a fast and effective method of accessing the parameters.

Thus, the network selects the optimum coding scheme for the mobile device and can account for service quality differences due to variations in cell topology, terrain and other environmental conditions. End user throughput is also often increased during the process of determining the optimal channel coding scheme to service a mobile device. The system is user-friendly and results in a pleasing user experience since adequate service quality is maintained.

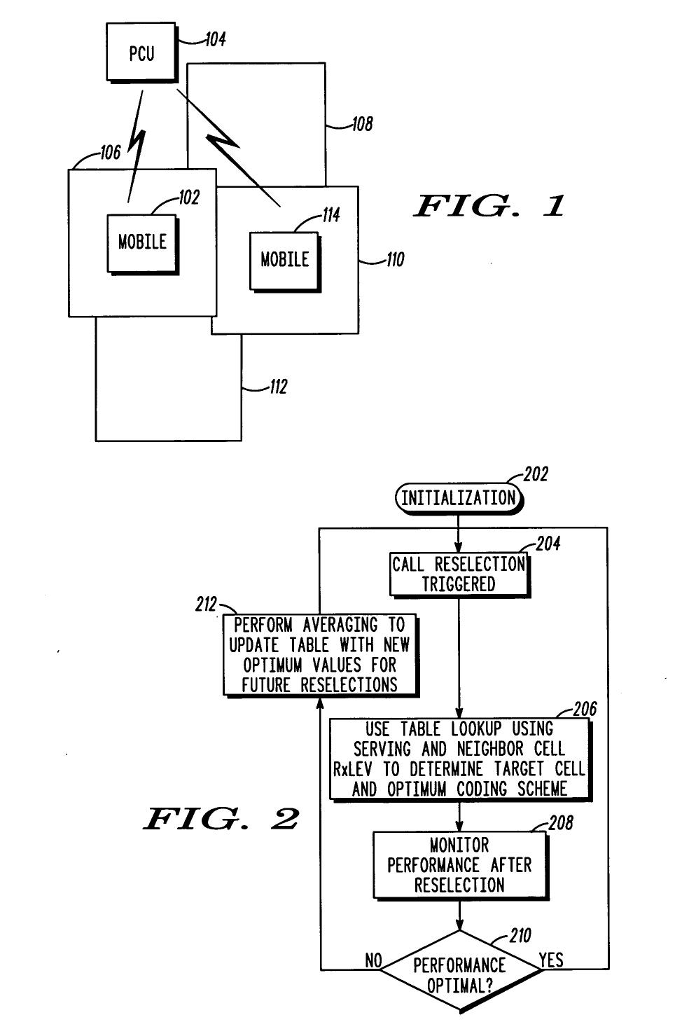

Referring now to FIG. 1, an example of a system for determining mobile device operating parameters using performance information is described. A first mobile unit 102 is located in a cell 106. A second mobile unit 114 is located within a cell 110. As shown in FIG. 1, the cells 108 and 112 have no mobile units located within their boundaries. However, it will be understood that the mobile units 102 and 114 may travel amongst the various cells shown in FIG. 1.

As the mobiles 102 and 114 move about the network, a mobile's operating performance characteristics, for example, its received RF signal strength, may be measured. As described in greater detail below, the reception of the performance information may trigger a reevaluation and changing of the operating parameters of the mobile. The functionality to change the operating parameters of the mobile unit may be located in the mobile, the network, or both the mobile and the network.

The cells 106, 108, 110, and 112 are conventional cells employed in telecommunication systems. The cells include telecommunication equipment, for example, base stations, that allow mobile units to communicate with other users and each other. It will also be understood that the exact boundaries and dimensions of the cells 106, 108, 110, and 112 may vary as is known in the art.

A packet control unit (PCU) 104 is communicatively coupled to the mobile unit 102, 114 and any other mobile units present and operating within the cells 106, 108, 110 and 112. The PCU 104 monitors performance information concerning the mobiles, for instance, Rx level measurements relayed by the mobiles 102 and 114 as part of the Packet Measurement Report (PMR) information periodically sent to the network. The PCU 104 also monitors the coding scheme of the mobiles 102 and 114 as well as other operating characteristics. Other examples of operating characteristics include error rate and block error rate.

During operation and movement across the network, the performance of the mobile unit 102 or 114 unit may deteriorate. For example, it may become difficult for the mobile unit 102 or 114 to communicate with other users or the perceived quality of service may deteriorate such that the service is no longer acceptable to the user.

Due to the deterioration of operating conditions, the PCU 104 may determine that operating parameters of the mobile unit 102 or 114 need to be changed. In one example, cell reselection is made so that the perceived quality of service at the mobile 102 or 114 is improved or stabilized. In another example of a parameter that may be altered, the coding scheme for the mobile unit 102 or 114 is changed by the PCU 104.

The cell reselection process allows the mobile unit to operate in a cell and use a coding scheme to give the mobile an improved or at least stabilized perceived quality of service. In one example, during cell reselection, the mobile unit may be issued a Packet Cell Change Order (PCCO) message from the PCU 104 in the network depending upon which neighboring cell the network considers as the best target cell for the mobile unit. The PCU 104 may also determine that the coding scheme or other operating parameters of the mobile unit 102 or 114 needs also to be changed.

The frequency of cell reselection made by the PCU 104 may vary. In some urban area networks, cell reselection may occur as often as every 15 seconds. In rural areas, the frequency of cell reselection may increase to minutes or longer.

While determining the identity of the new cell, the PCU 104 may use the Rx level of the serving cell and neighboring cells. The PCU 104 may also use the minimum Rx level required to access the neighbor cell and the congestion levels of each of the neighboring cells in making the determination.

As mentioned above, the PCU 104 may also dynamically adjust the coding scheme of the data sent to the mobile station by periodically monitoring various operating conditions of the mobile. For example, the PCU 104 may monitor the Block Error Rate (BER), missing downlink acknowledgements, stalls, BER probability, coefficient of variance of BER probability, and failed past datalink Temporary Block Flows (TBFs) or previous unsuccessful channel coding scheme selections. These conditions may be used, alone or in combination, and applied to coding scheme changing equations in order to determine a coding scheme. In one example, the coding scheme (CS) or mobile coding scheme (MCS) for a mobile unit is from CS1-CS4 (in the case of a GPRS system) and from MCS1-MSC9 (for an enhanced GPRS system).

In a preferred approach, every cell within the network has an associated table and the table includes entries representing new operating parameter information. Each entry in the table relates to and is a function of the Rx level of the serving cell and the Rx levels of at least one neighbor cell.

The PCU 104 may form and store the table in a memory. The PMR received by the PCU 104 from each mobile unit in a cell includes serving cell Rx level information and Rx level information of a predetermined number of neighbors, for example, six, at that point.

Using this information, an n-by-n matrix is generated on a per-cell basis, where n is some integer value. In one example, there can be a maximum of 32 neighbors that could be part of the common neighbor list at the network for the cell, and the table is a 32 by 32 matrix. This spatial table is populated from the information received from each mobile unit thus needing a maximum of 32 mobile units at different points in the cell sending PMRs to the serving cell. In this example, neighbor Rx level ranges from 0-63 for each neighbor in the common neighbor list. Rx level is the receive signal strength and common neighbor list is the network control neighbor list and is defined in 3GPP TS 44.060.

The spatial lookup table is initially populated with default coding scheme values and other default information. This default information may be computed by a mathematical function or relationship by the PCU 104. In one approach, the function C(S, N1, N2, . . . , Nn) is used to give the value of the coding scheme for a particular entry.

The function C(S, N1, N2, . . . , Nn) is a derived system of simultaneous equations with n unknowns where n is the maximum number of neighbors that can exist as part of a neighbor list. The equations represent the relationships amongst the neighbors at various points in the cell. The coefficients of each term are determined on the fly using previous cell reselection/coding scheme selection information with respect to success/failure of past attempts by other mobiles performing similar reselections. The PCU 104 monitors the coding scheme used to service the mobile unit in the target cell after cell reselection. Every time a change is detected of the coding scheme used by the mobile unit at a certain point in the cell, the function is preferably recalculated and the table is updated.

In one example, since each mobile unit can report a maximum of 6 neighbors (current standards) the coding scheme at any point in the cell can be derived by a minimum of 32 mobile units sending PMRs from different points in the cell. In other words, n may be 32.

As a result of the above-described tabular representation of combinations of Rx levels of serving cell and the neighboring cells in a network, the network is able to realize the different points in the cell where users could be experiencing inadequate throughput from the serving cell. Those mobile units could also be cell reselected to neighboring cells (depending upon their position in the serving cell) where they would experience better end-to-end throughput.

If and when a Network Controlled Cell Reselection/Network Assisted Cell Change (NACC) procedure takes place, the above spatial lookup table would be updated with the latest snapshot of the PMR received from the mobile unit before cell reselection. The coding scheme at the target cell is also monitored at the PCU 104 and updated as the C(S, N1, N2, . . . , Nn) value in the lookup table. This function C(S, N1, N2, . . . , Nn) gives the value of the coding scheme for that serving/neighbor cell combination.

The lookup table is now populated with the Rx level information of all its neighbors that could be perceived by the mobile unit at different positions in a cell. As a result, whenever a cell change order is issued to the mobile unit, then the network is able to choose the best target cell depending upon the coding scheme value from the lookup table.

To help in better planning of the network for an operator, information may be provided to an operator at a management console about the RF visualization of the network. For example, the management console may display information concerning the location and operating characteristics of the various mobile units in the cells in the network and the amount of usage in a particular cell. The operator can view the information displayed on the console and make further management decisions based upon the information displayed. This display is used to highlight holes in coverage and suboptimal RF planning. For instance, if a pair of cells are improperly planned so as to interfere with each other's RF path, a gap could be depicted in the display. Also, if there are discontinuities in coding scheme/throughput at the edge due to suboptimal neighbor configuration, then the display could show an abrupt change representing a discontinuity in perceived quality.

Referring now to FIG. 2, an example of a method for determining cell boundaries using a lookup table is described. At step 202, initialization occurs. For example, the look-up table is initialized with historical information that is maintained by the system. The historical information may include information that has been monitored over a long amount of time to give the initial value an adequate and realistic starting point. The historic information includes coding scheme data of the mobile unit at the target after the cell reselection that is updated every time a mobile unit performs a cell change. One table exists for each cell combination that is populated by multiple mobile units that perform cell changes between two cells.

At step 204, cell reselection is triggered when a PCU determines that the mobile unit may experience better radio conditions in neighboring cells. At that point, the network and/or mobile may make a determination to perform cell reselection. For example, the Rx level of the serving cell, minimum Rx level required to access the neighbor cell, and congestion levels of each of the neighbor cells may be considered in the determination of whether to perform cell reselection.

At step 206, a look-up table is used to determinate a target cell and optimum coding scheme. The table's contents may be accessed using the serving and neighbor cell Rx levels. Reselection is made. Although target cell and optimum coding scheme are the parameters selected and modified, it will be understood that other parameters may also be selected and modified.

At step 208, the system monitors performance of the mobile unit after the reselection decision is made. For example, the system may monitor the quality of received transmissions at the mobile unit. At step 210 it is determined whether performance is optimal (or at least meets such defined level of performance). Various tests and conditions can be used to make this determination. If different parameters are used to make the determination, the different parameters may be given different weights based upon the importance associated with these parameters by a user. If the answer at step 210 is affirmative, control continues at step 204. If the answer at step 210 is negative, control continues with step 212. At step 212, the system performs averaging to update the table with new optimal values for future reselections. Control then continues with step 204.

Thus, as described above, a system and method is provided that allows optimum parameters, including coding scheme and cell boundary, to be selected based upon performance characteristics of a mobile unit. The system and method allows for the use of a matrix and the initialization of the matrix can be made by using historical data to initially populate the matrix. In addition, the matrix itself can be updated to new optimum values thereby aiding in future reselection decisions.

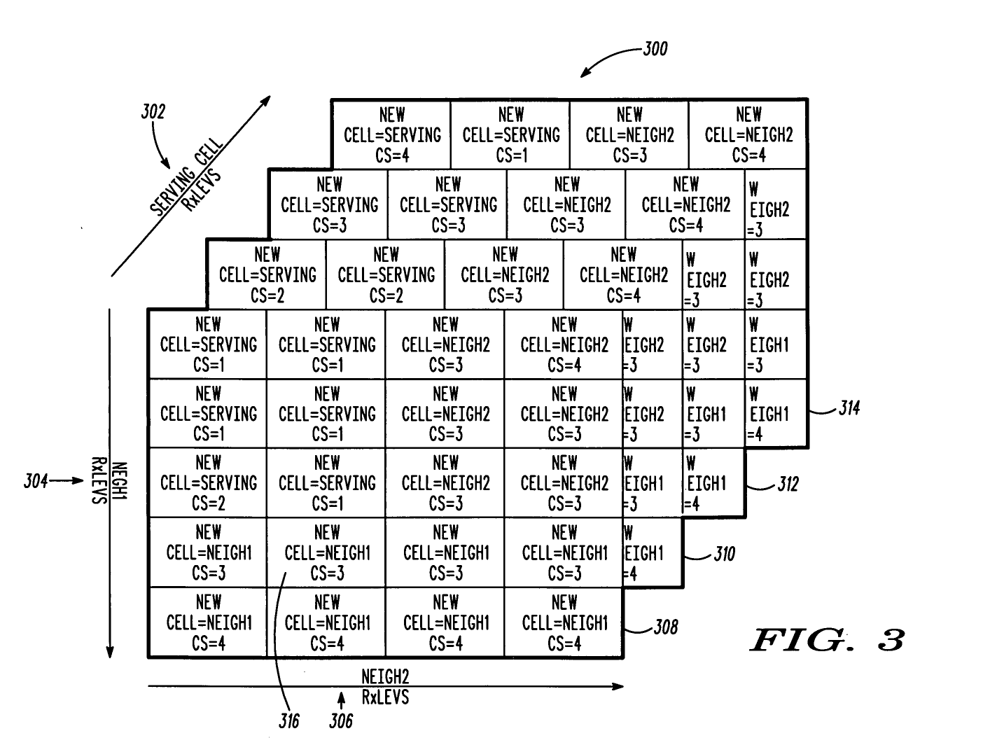

Referring now to FIG. 3, one example of a look-up table is described. The table 300 is a three-dimensional matrix having four x-y matrices 308, 310, 312 and 314. A y-axis 304 represents the Rx levels of a first neighbor dimension. An x-dimension 306 represents the Rx levels of a second neighbor. A z-axis 302 represents the Rx levels of the serving cells. Although a three-dimensional table is preferred, it will be understood that any number of dimensions may be used and that the axes may represent different performance characteristics.

The table is initialized with starting values and updated at runtime using actual results. The element also has an indication of the cell to use (e.g., serving cell, Neighbor Cell 1 or Neighbor Cell 2) and the coding scheme (CS) to use once the determination of cell has been made. The coding scheme may be any number of coding schemes, for example, GPRS or EGPRS. For convenience, the coding schemes in the table have been labeled coding schemes 1-4.

In this example, the system may determine the Rx level for a first neighbor cell, the Rx level for a second neighbor cell, and the Rx level for the serving cell of a mobile unit for which cell reselection has been initiated. The values obtained are used as an index to access one of the elements of the table 300. For instance, the three values may index a table entry 316. The table entry 316 indicates that the mobile unit will operate within neighbor cell 1 and will have a coding scheme of 3.

While there have been illustrated and described particular embodiments of the present invention, it will be appreciated that numerous changes and modifications will occur to those skilled in the art, and it is intended in the appended claims to cover all those changes and modifications which fall within the true spirit and scope of the present invention.

What is claimed is:

1. A method of determining selected operating parameters for a mobile unit comprising:
monitoring mobile device performance information in at least one neighboring cell and mobile device performance information in a serving cell; and
determining selected operating parameters of a mobile device based upon the mobile device performance information in the at least one neighboring cell and the mobile device performance information in the serving cell.

2. The method of claim 1 further comprising applying the selected operating parameters to the mobile device and determining whether at least one performance characteristic of the mobile device is improved using the selected operating parameters.

3. The method of claim 1 further comprising initializing the selected operating parameters of the mobile device based upon at least one stored historical measurement.

4. The method of claim 1 wherein the step of monitoring mobile device performance information in at least one neighboring cell comprises monitoring at least one mobile device received signal strength level in the at least one neighboring cell.

5. The method of claim 1 wherein determining the selected operating parameters comprises determining an optimum coding scheme and an optimum cell boundary.

6. The method of claim 5 wherein determining the selected operating parameters comprises performing a table look-up.

7. The method of claim 6 wherein determining the selected operating parameters comprises accessing a multi-dimensional array.

8. The method of claim 5 wherein monitoring the mobile device performance information comprises monitoring block error rate (BER), missing downlink acknowledgment, stalls, BER probability, coefficient of variance of BER probability, and failed past downlink TBFs.

9. A control unit for determining operating parameters of a mobile device comprising:
a receiver for receiving inputs representative of mobile device performance information in least one neighboring cell and mobile device performance information in a serving cell; and
a processor coupled to the receiver, the processor determining selected operating parameters of the mobile device based upon the mobile device performance information in the at least one neighboring cell and the serving cell.

10. The control unit of claim 9 wherein the processor further comprises means for applying the selected operating parameters to the mobile device and determining whether at least one performance characteristic of the mobile device is improved using the applied operating parameters.

11. The control unit of claim 9 wherein the processor further comprises means for initializing the selected operating parameters of the mobile device based upon at least one stored historical measurement.

12. The control unit of claim 9 wherein the processor further comprises means for monitoring mobile device received signal strength levels in the at least one neighboring cell.

13. The control unit of claim 9 wherein the processor further comprises means for determining an optimum coding scheme and optimum cell boundary.

14. The control unit of claim 13 wherein the processor further comprises means for performing a table look-up.

15. The control unit of claim 14 wherein the look-up table is a multi-dimensional array.

16. The control unit of claim 13 wherein the processor further comprises means for monitoring block error rate (BER), missing downlink acknowledgment, stalls, BER probability, coefficient of variance of BER probability, and failed past downlink TBFs.
